(19) United States
(12) Patent Application Publication
(10) Pub. No.: US 2014/0138421 A1
(43) Pub. Date: May 22, 2014

(54) SEPARATION APPARATUSES AND METHODS FOR SEPARATING GLASS SHEETS FROM GLASS RIBBONS

(71) Applicant: Corning Incorporated, Corning, NY (US)

(72) Inventors: Gregory Clifford Gagnon, Jacksonville, FL (US); Yu-Chang Hong, Taichung City (TW); Meng-Kai Shih, Kaohsiung City (TW)

(73) Assignee: Corning Incorporated, Corning, NY (US)

(21) Appl. No.: 14/077,922

(22) Filed: Nov. 12, 2013

Related U.S. Application Data
(60) Provisional application No. 61/727,462, filed on Nov. 16, 2012.

(51) Int. Cl. C03B 33/033; C03B 33/023

(52) U.S. Cl. CPC C03B 33/033; C03B 33/0235
USPC 225/2; 225/96

(57) ABSTRACT

Apparatuses and methods are described for separating glass sheets from glass ribbons. In one embodiment, a glass substrate separation apparatus comprises a support nosing. The support nosing comprises a nosing material having a Shore hardness greater than 64A and less than or equal to 80A and a coefficient of friction less than or equal to 1.2 relative to a glass substrate. The apparatus also comprises a scoring device opposing the support nosing and an actuator coupled to the support nosing for engaging the support nosing with the glass substrate.

### CROSS REFERENCE TO RELATED APPLICATIONS

This application claims the benefit of priority under 35 U.S.C. §119(e) of U.S. Provisional Application Serial No. 61/727462 filed on Nov. 16, 2012, the content of which is incorporated herein by reference in its entirety.

### BACKGROUND

1. Field

The present specification generally relates to apparatuses and methods for forming glass sheets from glass ribbons and, more particularly, to apparatuses and methods of scoring and separating glass sheets from glass ribbons.

2. Technical Background

Glass ribbons may be formed by processes such as the fusion draw process or other similar downdraw processes. The fusion draw process yields glass ribbons which have surfaces with superior flatness and smoothness when compared to glass ribbons produced by other methods. Individual glass sheets sectioned from glass ribbons formed by the fusion draw process can be used in a variety of devices including flat panel displays, touch sensors, photovoltaic devices and other electronic applications.

Glass ribbons formed by the fusion draw process often bow or curve in a lateral direction due to temperature gradients in the glass as it cools. After the glass ribbon is drawn, individual sheets of glass are sectioned from the ribbon by supporting the glass ribbon with a nosing device as the glass ribbon is scored and separated along an intended line of separation, or scoring line. When a nosing device is used to support the glass ribbon during scoring, the curved glass ribbon may be flattened when the scoring device engages with the curved glass ribbon. However, when the curved glass ribbon is flattened on the nosing device, compressive stress is introduced into the glass ribbon, which may prevent complete scoring. The contact between the scoring device and the curved glass ribbon also introduces motion in the ribbon, which may be propagated upstream of the scoring device and cause undesirable stress and warp in the ribbon. Additionally, if the scoring device does not create a vent of sufficient depth in the glass ribbon, a bending moment applied to the glass ribbon to bend the glass ribbon against the support nosing and separate a glass sheet from the glass ribbon at the score line will introduce stress in the glass ribbon in the support nosing contact area which may cause unwanted breakage or fractures of the glass sheet or the glass ribbon adjacent to the scoring line.

Accordingly, a need exists for alternative apparatuses and methods of separating glass sheets from glass ribbons to prevent unwanted breakage or fractures.

### SUMMARY

According to one embodiment, a glass substrate separation apparatus comprises a support nosing. The support nosing comprises a nosing material having a Shore hardness greater than 64 A and less than or equal to 80 A and a coefficient of friction less than or equal to 1.2 relative to a glass substrate. The apparatus also comprises a scoring device opposing the support nosing and an actuator coupled to the support nosing for engaging the support nosing with the glass substrate.

In another embodiment, a method for separating a glass sheet from a glass ribbon is provided. The method comprises drawing the glass ribbon along a conveyance pathway and directing the glass ribbon through a separation apparatus comprising a support nosing and a scoring device. The conveyance pathway is positioned between the support nosing and the scoring device. The method includes engaging a nosing material of the support nosing with at least a portion of a first surface of the glass ribbon, engaging the scoring device with a second surface of the glass ribbon along an intended line of separation, wherein the intended line of separation lies along the support nosing, and traversing the scoring device over the second surface of the glass ribbon on the intended line of separation to introduce a partial vent in the second surface of the glass ribbon. The nosing material has a sufficiently low coefficient of friction relative to the first surface of the glass such that lateral edges of the glass ribbon slide against the nosing material in a lateral direction and the first surface of the glass ribbon contacts the nosing material as the scoring device traverses over the second surface of the glass ribbon, and the nosing material has a sufficiently high hardness such that the partial vent extends across the entire width of the glass ribbon.

In another embodiment, a method for separating a glass ribbon comprises positioning the glass ribbon proximate to a support nosing and engaging the glass ribbon with the support nosing using an actuator. The support nosing comprises a nosing material having a Shore hardness from 64 A to less than or equal to 80 A and a coefficient of friction less than or equal to 1.2 relative to the glass ribbon. The method also includes scoring the glass ribbon with a scoring device positioned opposite the support nosing along an intended line of separation to form a partial vent in a surface of the glass ribbon, wherein the scoring device flattens the glass ribbon against the nosing. The method also includes applying a bending moment to the glass ribbon to propagate the vent through the thickness of the glass ribbon.

Additional features and advantages of the embodiments described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a cross section of a separation apparatus with a support nosing for use in conjunction with one or more embodiments of the methods for separating a glass sheet from a glass ribbon described herein;

FIG. 2 schematically depicts an exemplary glass manufacturing apparatus utilizing a support nosing to separate a glass sheet from a ribbon of glass;

FIG. 3 schematically depicts a partial cross section of the exemplary glass manufacturing apparatus of FIG. 2;

FIGS. 4A-4C schematically depict the separation apparatus with support nosing of FIG. 1 being used to separate a glass sheet from a glass ribbon according to one or more embodiments shown and described herein; and

FIGS. 5A-5B illustrate experimental test results associated with one embodiment of the disclosure.

### DETAILED DESCRIPTION

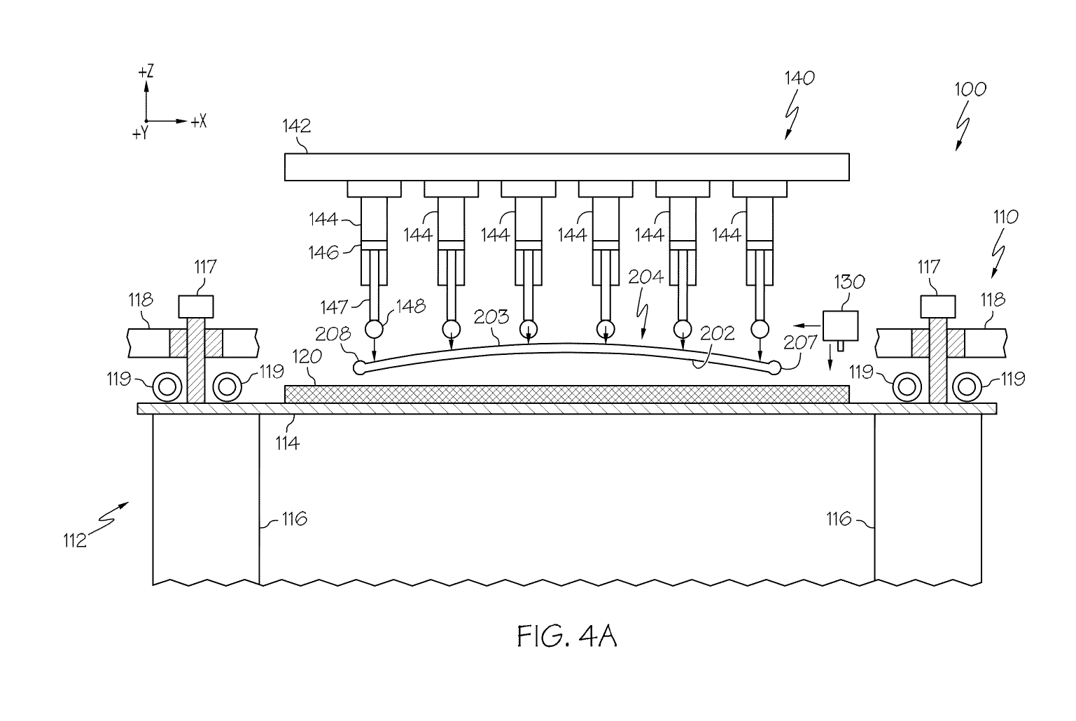

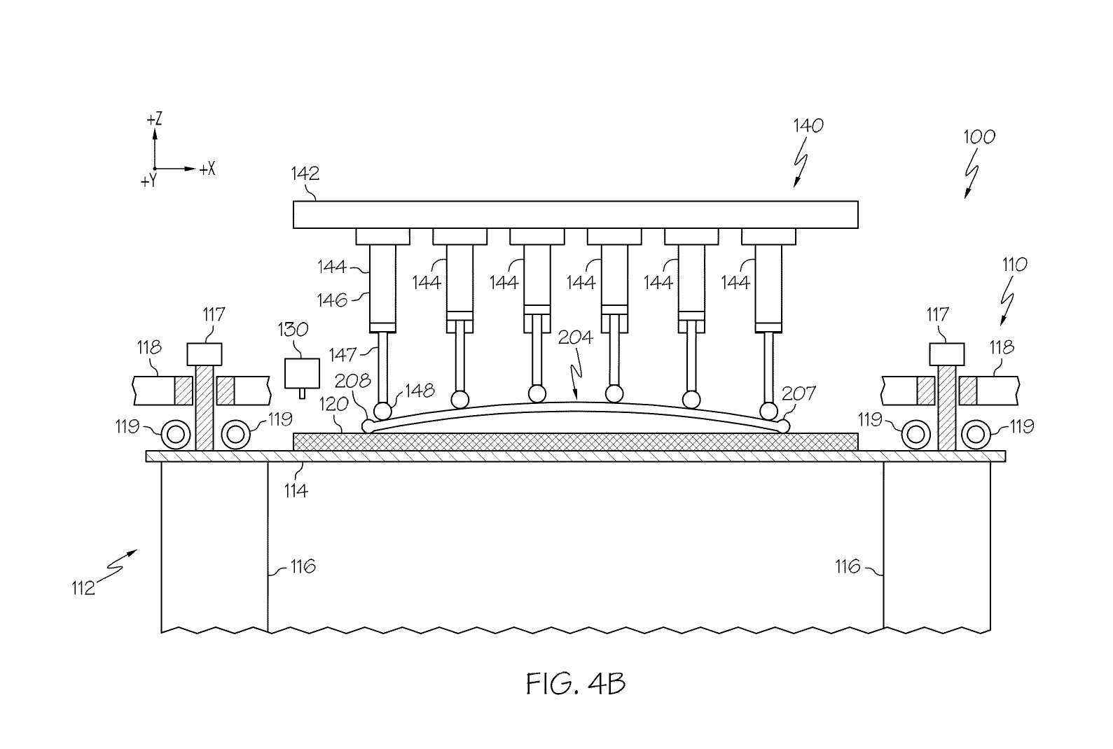

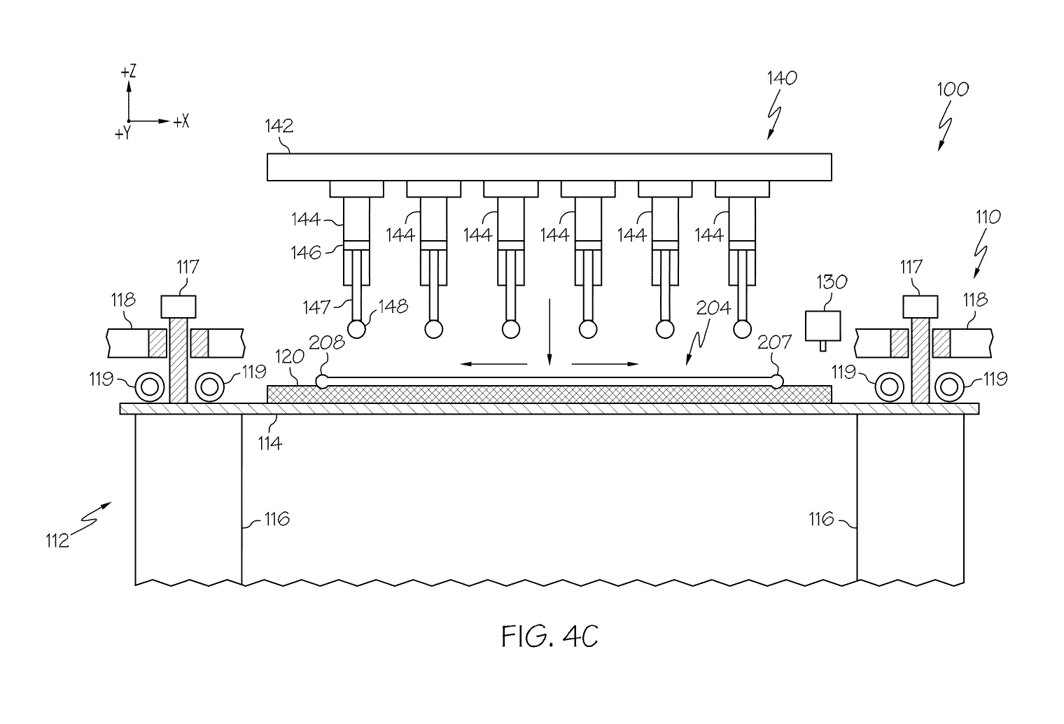

Reference will now be made in detail to various embodiments of apparatuses and methods for separating glass sheets from glass ribbons, examples of which are illustrated in the accompanying drawings. Whenever possible, the same reference numerals will be used throughout the drawings to refer to the same or like parts. FIGS. 4A through 4C schematically depict one embodiment of an apparatus and method for separating a glass sheet from a glass ribbon. The method generally comprises positioning a glass ribbon proximate to a support nosing and engaging the glass ribbon with the support nosing using an actuator. The support nosing comprises a nosing material having a Shore hardness from 64 A to less than or equal to 80 A and a coefficient of friction less than or equal to 1.2 relative to the glass ribbon. The glass ribbon is scored with a scoring device positioned opposite the support nosing along an intended line of separation to form a partial vent in a surface of the glass ribbon. A bending moment is then applied to the glass ribbon to propagate the vent through the thickness of the glass ribbon, thereby separating a glass sheet from the glass ribbon. Apparatuses and methods for separating a glass sheet from a glass ribbon and support nosing for use with such methods will be described in more detail herein with specific reference to the appended figures.

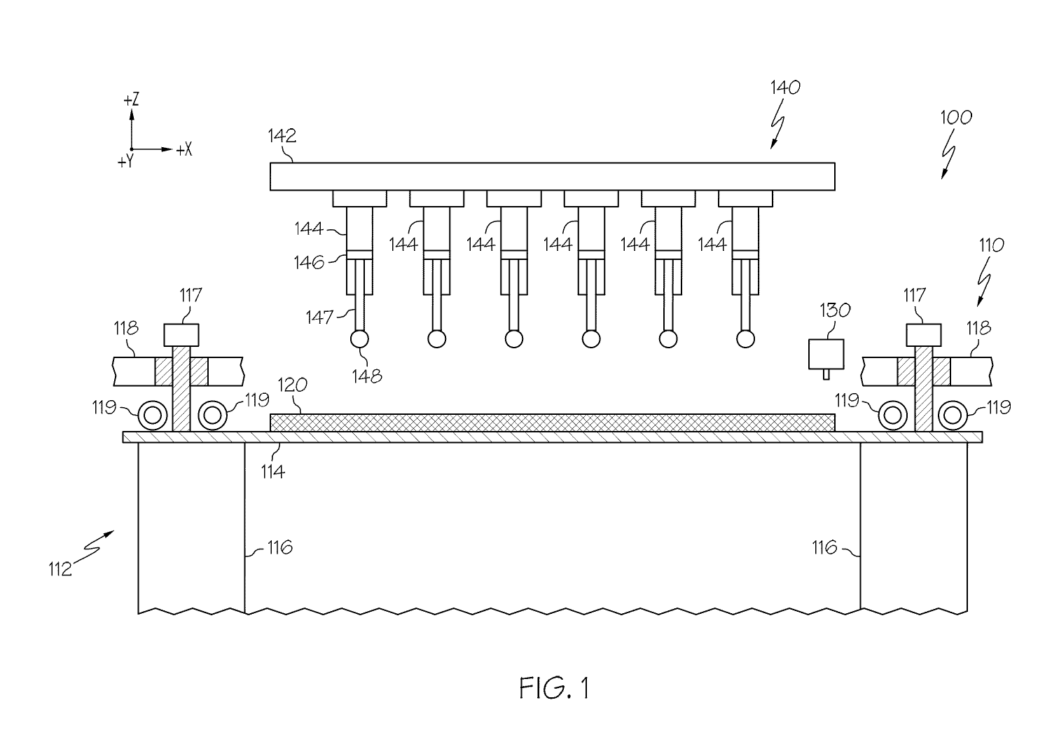

Referring now to FIG. 1, one embodiment of a separation apparatus 100 with a support nosing 110 is schematically depicted in cross section. The separation apparatus 100 may be used in conjunction with one or more embodiments of the apparatuses and methods for separating a glass sheet 205 from a glass ribbon 204 shown and described herein. The separation apparatus 100 generally comprises the support nosing 110 and a scoring device 130. In the embodiment depicted in FIG. 1, the separation apparatus 100 also comprises a passive support device 140. However, it should be understood that in alternative embodiments, the separation apparatus 100 may be constructed without the passive support device 140. In these embodiments, the separation apparatus 100 comprises the support nosing 110 and the scoring device 130.

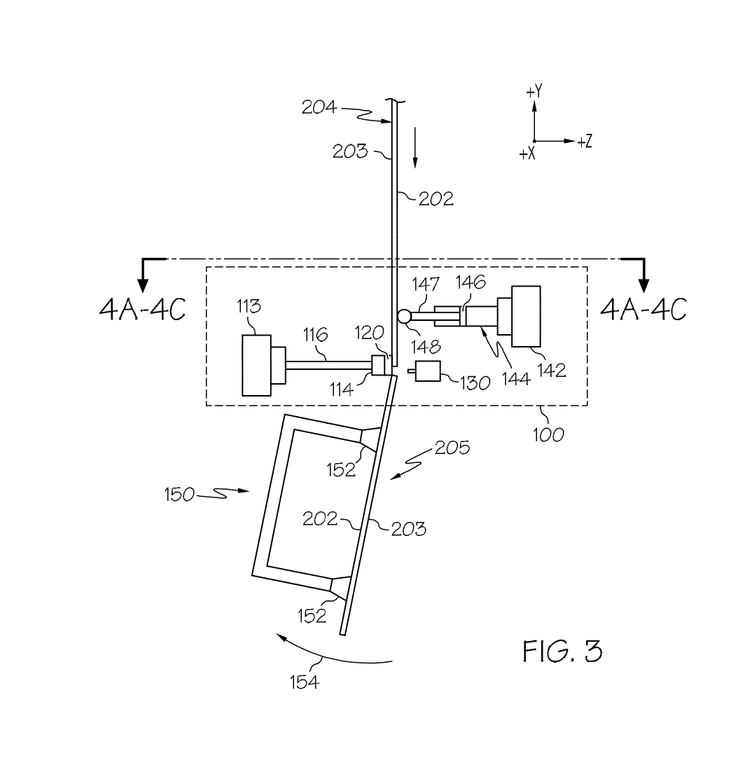

Still referring to FIG. 1, the support nosing 110 generally comprises a support frame 112 and a beam 114. The beam 114 may be linearly fixed, as shown in FIG. 1. However, in other embodiments, the beam 114 may be flexible to facilitate conforming the support nosing 110 to a curvature of the glass ribbon 204. A suitable conformable nosing device for use in conjunction with the apparatuses and methods described herein is disclosed in U.S. Pat. No. 7,895,861 and entitled “Conformable nosing device for reducing motion and stress within a glass sheet while manufacturing the glass sheet,” the entirety of which is incorporated herein by reference. In the embodiment depicted in FIG. 1, the support frame 112 includes a pair of support arms 116 connected to an actuator 113 (shown in FIG. 3). However, it should be understood that other configurations of the support frame 112 and actuator 113 are possible.

The beam 114 may be formed from a material such as steel or an elastically deformable metallic alloy. The beam 114 is attached to the support frame 112 such that the beam 114 extends in the ±x-direction past both of the support arms 116. In the embodiment depicted in FIG. 1, the beam 114 is attached to the support arms 116 with a pair of posts 117 secured in brackets 118. In one embodiment, the posts 117 are threadably secured in the brackets 118. The posts 117 exert a pressure against the beam 114 securing the beam 114 against the support arms 116. In the embodiment shown in FIG. 1, a plurality of rollers 119 are also used to secure the beam 114 against the support arms 116. In some embodiments, the rollers 119 permit the beam 114 to be displaced in the ±x-direction. In some other embodiments, the posts 117 fixedly secure the beam 114 to the support arms 116 thereby preventing the beam 114 from being displaced.

A nosing material 120 is attached to an upper surface of the beam 114 (i.e., the surface of the beam 114 facing away from the support frame 112). The nosing material 120 may be constructed from rubber, steel or any other material having the material properties discussed below. A non-limiting example of a suitable nosing material 120 can be obtained from Dajia Technology Company, Ltd under the commercial name silicone rubber. In one embodiment described herein, the nosing material 120 has a Shore hardness greater than 64 A. The Shore hardness, as used herein, refers to the hardness of the material according to the Shore “A” scale. In another embodiment, the nosing material 120 has a Shore hardness less than or equal to 80 A. In other embodiments described herein, the nosing material 120 has a Shore hardness greater than 64 A and less than or equal to 80 A. In another embodiment described herein, the nosing material 120 has a Shore hardness greater than 65 A and less than or equal to 75 A. In yet another embodiment described herein, the nosing material 120 has a Shore hardness greater than 68 A and less than or equal to 70 A.

The nosing material 120 has a coefficient of friction less than or equal to 1.2 relative to the glass ribbon 204. In some embodiments, the nosing material 120 has a coefficient of friction relative to the glass ribbon 204 less than or equal to 1.0. The coefficient of friction of the nosing material 120, as used herein, is with respect to a glass ribbon in as-formed condition prior to any surface treatment such as surface roughness modification or the like. In other embodiments, the nosing material 120 has a coefficient of friction relative to the glass ribbon 204 greater than 0.8. In another embodiment, the nosing material 120 has a coefficient of friction relative to the glass ribbon 204 greater than or equal to 0.8 and less than or equal to 1.2. In yet another embodiment, the nosing material 120 has a coefficient of friction relative to the glass ribbon 204 greater than or equal to 0.8 and less than or equal to 1.0. In different embodiments, the nosing material 120 may have a coefficient of friction of 0.8 or 0.9 or 1.0, or 1.1 relative to the glass, or any other coefficient of friction less than or equal to 1.2.

In order for the scoring device 130 to consistently create a uniform vent along an entire intended line of separation in the glass ribbon 204, the support nosing 110 opposing the scoring device 130 should have a nosing material 120 attached to the support nosing 110 that is sufficiently hard to allow the scoring device 130 to initiate a vent of uniform depth in a surface of the glass ribbon 204. The term “vent,” as used herein, refers to a defect, such as a nick, scratch, or the like, introduced into the surface of the substrate which serves as an initiation site and guide for controlled crack propagation during subsequent separation. If the nosing material 120 is not sufficiently hard, the glass ribbon 204 may flex upon contact with the scoring device 130, inducing compressive stress in the glass which increases the difficulty of initiating a vent in a surface of the glass ribbon 204. This prevents the glass sheet 205 from being cleanly separated from the glass ribbon 204. If the nosing material 120 is too hard, on the other hand, the scoring device 130 may not only initiate a vent in a surface of the glass ribbon 204, but immediately propagate the vent through the glass ribbon 204, causing uncontrolled and undesirable separation of the glass sheet from the glass ribbon. The nosing material 120 with a Shore hardness greater than 64 A and less than or equal to 80 A provides a surface hard enough to satisfactorily initiate a vent of uniform depth in a surface of the glass ribbon 204 without immediately propagating the vent through the glass ribbon 204.

The glass ribbon 204 may have a bowed or curved structure by the time the glass ribbon 204 is between the support nosing 110 and the scoring device 130, as illustrated in FIG. 4A. When the scoring device 130 begins to score the glass ribbon 204, initially only the edges 207, 208 of the glass ribbon 204 are in contact with the nosing material 120. However, as the scoring device 130 applies pressure to the glass ribbon 204 and moves across an intended line of separation, the glass ribbon 204 is flattened against the nosing material 120. Thus, by the time the scoring device 130 is roughly halfway across the glass ribbon 204, the glass ribbon 204 is completely flattened against the nosing material 120, as shown in FIG. 4C. The coefficient of friction of the nosing material 120 of less than 1.2 relative to the glass ribbon 204 allows edges 207, 208 of the glass ribbon 204 to slide smoothly in opposite directions on the nosing material 120 during scoring. If the coefficient of friction of the nosing material 120 relative to the glass ribbon 204 is greater than 1.2, the glass ribbon 204 may not be easily flattened during scoring. This can result in, for example, the glass ribbon 204 hanging up on certain parts of the nosing material 120, which may lead to unwanted breakage.

In the embodiment shown in FIG. 1, the scoring device 130 comprises a mechanical scoring component, such as a scoring wheel or scoring point. The scoring device 130 is coupled to an actuator (not shown) which is operable to traverse the scoring device 130 in the ±x-direction relative to the support frame 112. The scoring device 130 is also coupled to an actuator (not shown) which facilitates positioning the scoring device in the ±z-direction as the scoring device 130 is traversed in the ±x-direction. To facilitate engaging the scoring device 130 with the glass ribbon 204 drawn through the separation apparatus 100, the scoring device 130 is positioned in the y-direction such that the scoring device 130, specifically the scoring wheel or scoring point, is directly opposite the support nosing 110, as depicted in FIG. 3. Accordingly, it should be understood that the scoring device 130 may be utilized to score the glass ribbon 204 along an intended line of separation, or scoring line, to remove a glass sheet 205 from the glass ribbon 204. During scoring, the glass ribbon 204 is supported by the support nosing 110 such that a partial vent may be formed in the surface of the glass ribbon 204 opposite the support nosing 110. A suitable scoring device for use in conjunction with the apparatuses and methods described herein is disclosed in U.S. Patent Application Publication No. 2008/0276785 filed May 9, 2007 and entitled “Constant Force Scoring Device and Method For Using the Same,” the entirety of which is incorporated herein by reference.

In the embodiment of the separation apparatus 100 with the support nosing 110 depicted in FIG. 1, the separation apparatus 100 also includes a passive support device 140. The passive support device 140 comprises a support bar 142 on which a plurality of constant force air cylinders 144 are positioned (six shown in FIG. 1). Each air cylinder 144 comprises a piston 146 to which a shaft 147 is coupled. The shaft 147 may be extended and retracted from the air cylinder 144 as mechanical pressure is applied to a contact point 148 of each shaft 147. The contact points 148 of the air cylinder 144 may be formed from a rubber material, a ceramic material, ruby, or any other suitable material for contacting glass without scratching or damaging the glass. In the embodiments of the separation apparatus 100 described herein, the contact points 148 are generally offset from the beam 114 of the support nosing 110 in the positive y-direction such that the contact points 148 do not directly oppose the beam 114 of the support nosing 110, as depicted in FIG. 3. The air cylinders 144 can be controlled by a device such as an actuator, servo, robotic arms, CNC positioning devices, pneumatic cylinders, hydraulic cylinders, or the like, such that the passive support device 140 may be positioned relative to the support nosing 110 in the ±z-direction. The passive support device 140 is used to secure and stabilize the glass ribbon 204 as the glass ribbon 204 is scored and separated thereby reducing excessive motion and vibration in the glass ribbon 204 and preventing such motion from propagating upstream of the separation apparatus 100 (in the positive y-direction). Specifically, the constant force air cylinders 144 hold the glass ribbon 204 to the nosing material 120 of the beam 114 as the scoring device 130 traverses over the glass ribbon 204 thereby scoring the glass ribbon 204, as will be described in more detail herein.

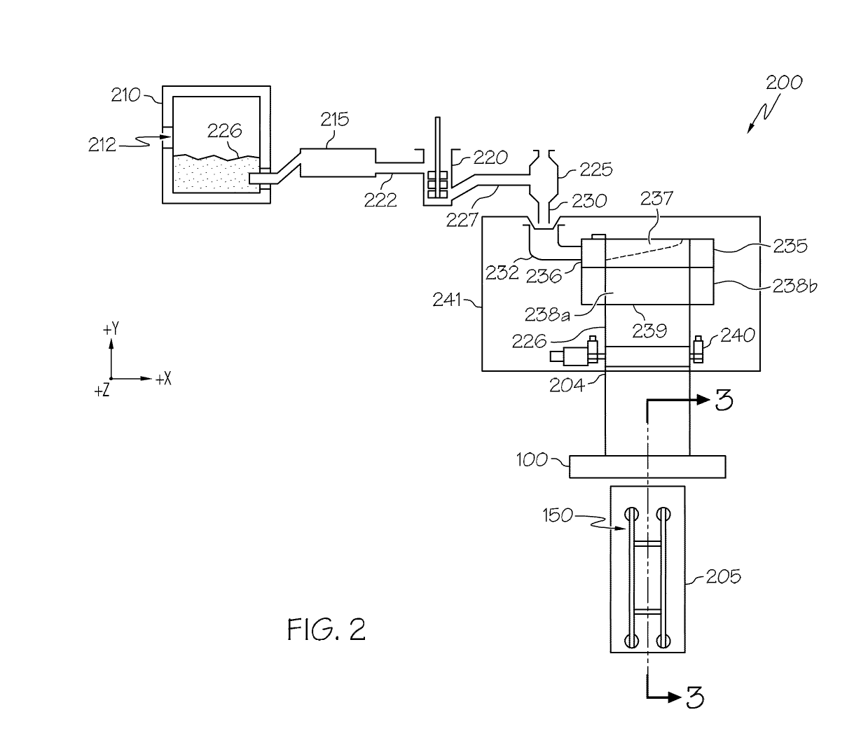

The method of using the separation apparatus 100 with support nosing 110 to separate the glass sheet 205 from the glass ribbon 204 will now be described in more detail with reference to FIGS. 2, 3 and 4A-4C.

Referring now to the embodiment of a glass manufacturing apparatus 200 schematically depicted in FIG. 2 and the partial cross section of the apparatus 200 depicted in FIG. 3, a pull roll assembly 240 delivers a continuous glass ribbon 204 (which at this point in the manufacturing process may have a curved shape) to the separation apparatus 100, which includes the support nosing 110 and the scoring device 130 described above. As shown in FIGS. 4A-4C, the continuous glass ribbon 204 is drawn through the separation apparatus 100 between the passive support device 140 and the support nosing 110. Initially, the passive support device 140 and the support nosing 110 are in neutral positions such that neither the passive support device 140 nor the support nosing 110 makes contact with the continuous glass ribbon 204, as illustrated in FIG. 4A. The passive support device 140 can then be actuated to support the continuous glass ribbon 204.

In FIG. 4B, the passive support device 140 is depicted engaged with the glass ribbon 204. Each shaft 147 of the passive support device 140 is extended such that the contact points 148 make contact with the glass ribbon 204. Thereafter, the support nosing 110 is engaged with a first surface 202 of the glass ribbon 204 such that the nosing material 120 makes contact with at least a portion of the first surface 202. In the embodiment shown in FIG. 4B, the nosing material makes contact with the beads on the edges 207, 208 of the glass ribbon 204. In this embodiment, the beam 114 and nosing material 120 are advanced towards the first surface 202 of the glass ribbon 204 until the nosing material 120 attached to the beam 114 engages the edges 207, 208 of the first surface 202 of the glass ribbon 204 along a support nosing contact line. The support nosing contact line, as used herein, refers to the line of contact between the first surface 202 of the glass ribbon 204 and the nosing material 120 of the beam 114.

The contact points 148 of the passive support device 140 may be advanced towards the support nosing 110 (i.e., the passive support device is advanced in the negative z-direction) until the contact points 148 of the passive support device 140 engage with the second surface 203 of the glass ribbon 204. In this embodiment, the glass ribbon 204 is impinged between the contact points 148 of the passive support device 140 and the nosing material 120 of the support nosing 110. The contact points 148 of the passive support device 140 engage with the second surface 203 of the glass ribbon 204 along a passive support contact line which is generally offset from the support nosing contact line in an upstream direction (i.e., in the positive y-direction as schematically illustrated in FIG. 4B) such that the second surface 203 of the glass ribbon can be scored opposite the nosing material 120.

Still referring to FIG. 4B, after the support nosing 110 is engaged with the first surface 202 of the glass ribbon 204, the scoring device 130 is utilized to score the glass ribbon 204 along an intended line of separation on the second surface 203 of the glass ribbon 204. Specifically, the scoring device 130 is brought into contact with the second surface 203 of the glass ribbon 204 and is traversed over the second surface 203 of the glass ribbon 204 in the x-direction along an intended line of separation which is opposite the support nosing contact line on the first surface 202 of the glass ribbon 204. The glass ribbon 204 is supported with the support nosing 110 as the scoring device 130 is traversed over the second surface 203 of the glass ribbon 204 and the glass ribbon 204 is flattened against the nosing material 120 as the scoring device 130 applies a pressure against the glass ribbon 204. As the scoring device 130 traverses the second surface 203 of the glass ribbon 204, the edges 207, 208 of the glass ribbon are able to slide in the x-direction along the nosing material 120 because of the low coefficient of friction relative to the glass ribbon 204, allowing the glass ribbon 204 to smoothly flatten across the nosing material 120 while the scoring device 130 is in contact with the second surface 203 of the glass ribbon 204. The nosing material 120 thereby reduces the propensity for buckling, breakage, vent loss, or hackle by allowing the glass ribbon 204 to flatten against the nosing material 120.

Depending on the thickness of the glass ribbon 204 and the resulting curvature, buckling or compressive stress can be introduced in the glass sheet 205 or glass ribbon 204 during scoring. For example, a glass ribbon 204 with a thickness less than 0.4 mm may have more curvature than a glass ribbon 204 with a thickness of 0.5 mm, which may lead to greater buckling of the ribbon during scoring. Additionally, the thickness of the glass ribbon 204 affects the ability of the glass ribbon 204 to be flattened against the nosing material 120 when the scoring device 130 applies pressure during scoring. When the glass ribbon 204 is not adequately supported by the support nosing 110, the scoring device 130 creates a compressive stress along the intended line of separation, which may result in vent loss or hackle. With a glass ribbon 204 less than 0.4 mm thick, the likelihood of vent loss or hackle is increased. In addition to buckling, breakage, and fractures, the edge quality of the glass sheet 205 is affected when the glass ribbon 204 cannot be flattened. The nosing material 120, with Shore hardness greater than 64 A and less than or equal to 80 A prevents buckling and compressive stress in the glass ribbon 204 and reduces vent loss or hackle by providing a surface opposite the scoring device 130 that allows the scoring device 130 to apply sufficient pressure during scoring. In turn, this allows the subsequently applied bending moment to propagate the vent and separate the glass sheet 205 from the glass ribbon 204.

Referring back to FIG. 3, after the glass ribbon 204 is scored, a bending moment is applied to the glass ribbon 204 to separate the glass sheet 205 from the glass ribbon 204 at an intended line of separation (i.e., the vent). In one embodiment, the bending moment is applied to the glass ribbon 204 with a carriage 150 as depicted in FIG. 3. The carriage 150 is shuttled into place with an actuator (not shown), such as a robotic arm or a similar actuator, and attached to the glass ribbon 204 downstream of the support nosing 110 (i.e., in the negative y-direction in FIG. 3) using vacuum chucks 152 or similar tooling for securing a glass sheet. After the carriage 150 is attached to the glass ribbon 204, a bending moment is applied to the glass ribbon 204 by pivoting the carriage 150 towards the support nosing as indicated by arrow 154. The applied bending moment bends the glass ribbon against the support nosing 110.

Prior to bending, the glass ribbon is again bowed (i.e., the glass ribbon has some spring back following removal of the scoring device). As the bending moment is applied to the glass ribbon 204, the curvature of the glass ribbon 204 tends to flatten, assisted by the low coefficient of friction of the nosing material 120. As such, application of the bending moment to the glass ribbon 204 flattens the glass ribbon 204 against the nosing material 120 thereby reengaging the glass ribbon 204 with the support nosing 110 across the width of the ribbon. Because the low coefficient of friction allows the glass ribbon 204 to slide on the nosing material 120, uncontrolled breakage of the glass sheet 205 or the glass ribbon 204 in areas adjacent to the scribing line is prevented as the glass ribbon 204 is bent against the support nosing 110. Once the curvature of the glass ribbon 204 is almost flattened against the nosing material 120 as depicted in FIG. 4C, continued application of the bending moment causes the glass sheet 205 to separate from the glass ribbon 204 along the vent, as depicted in FIG. 3, without uncontrolled breakage adjacent to the vent.

Referring again to FIG. 2, the methods and apparatuses for separating glass sheets may be used in a variety of glass manufacturing apparatuses. One embodiment of an exemplary glass manufacturing apparatus 200 is schematically depicted in FIG. 2. The glass manufacturing apparatus utilizes the separation apparatus 100 with the support nosing 110 as depicted in FIG. 1. The glass manufacturing apparatus 200 includes a melting vessel 210, a fining vessel 215, a mixing vessel 220, a delivery vessel 225, a fusion draw machine (FDM) 241 and separation apparatus 100. Glass batch materials are introduced into the melting vessel 210 as indicated by arrow 212. The batch materials are melted to form molten glass 226. The fining vessel 215 has a high temperature processing area that receives the molten glass 226 from the melting vessel 210 and in which bubbles are removed from the molten glass 226. The fining vessel 215 is fluidly coupled to the mixing vessel 220 by a connecting tube 222. The mixing vessel 220 is, in turn, fluidly coupled to the delivery vessel 225 by a connecting tube 227.

The delivery vessel 225 supplies the molten glass 226 through a downcomer 230 into the FDM 241. The FDM 241 comprises an inlet 232, a forming vessel 235, and the pull roll assembly 240. As shown in FIG. 2, the molten glass 226 from the downcomer 230 flows into the inlet 232 which leads to the forming vessel 235. The forming vessel 235 includes an opening 236 that receives the molten glass 226 which flows into a trough 237 and then overflows and runs down two sides 238a and 238b before fusing together at a root 239. The root 239 is where the two sides 238a and 238b come together and where the two overflow walls of molten glass 226 rejoin before being drawn downward by the pull roll assembly 240 to form the glass ribbon 204.

As the glass ribbon 204 exits the pull roll assembly 240, the molten glass solidifies. Due to the differences in the thickness of the molten glass at the edges and center of the glass ribbon 204, the center of the glass ribbon 204 cools and solidifies more quickly than the edges of the glass ribbon 204 creating a temperature gradient from the edges to the center of the glass ribbon 204. As the molten glass cools, the temperature gradient causes stresses to develop in the glass which, in turn, causes the glass to bow or curve in a lateral direction (in the direction from one edge of the glass to the other). Generally, the thinner the glass ribbon 204, the more the glass curves. Once the glass ribbon 204 has solidified, it may be conveyed into the glass separation apparatus 100 for segmentation into sheets, as described above.

While the glass separation apparatus has been described herein as being used in a fusion draw process, it should be understood that the glass separation apparatus may be used with other types of glass manufacturing apparatuses including slot draw apparatuses, or other draw down apparatuses.

### EXAMPLES

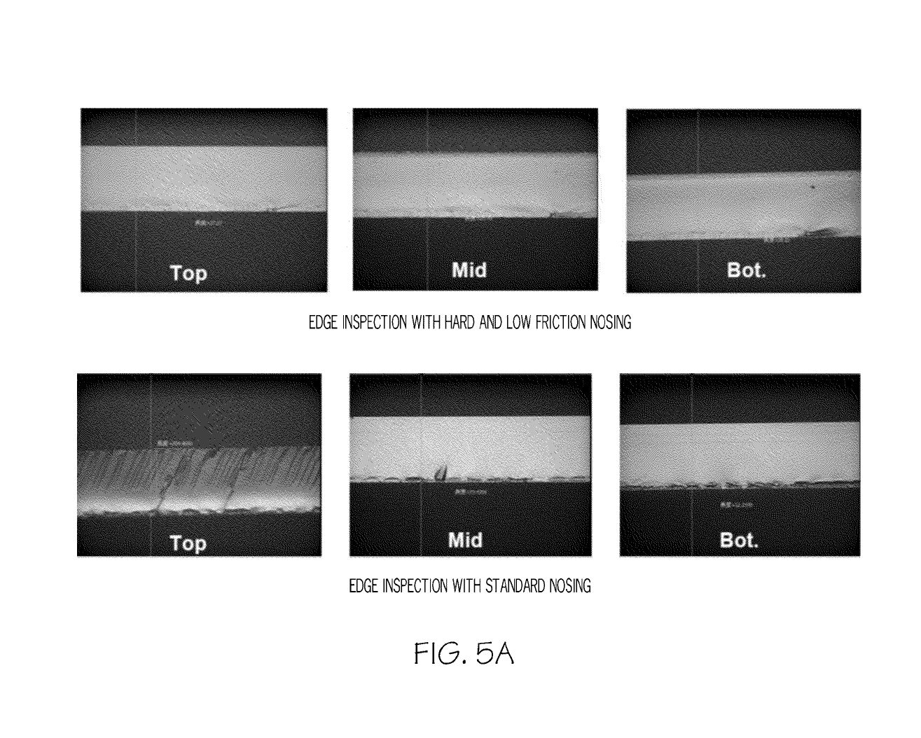

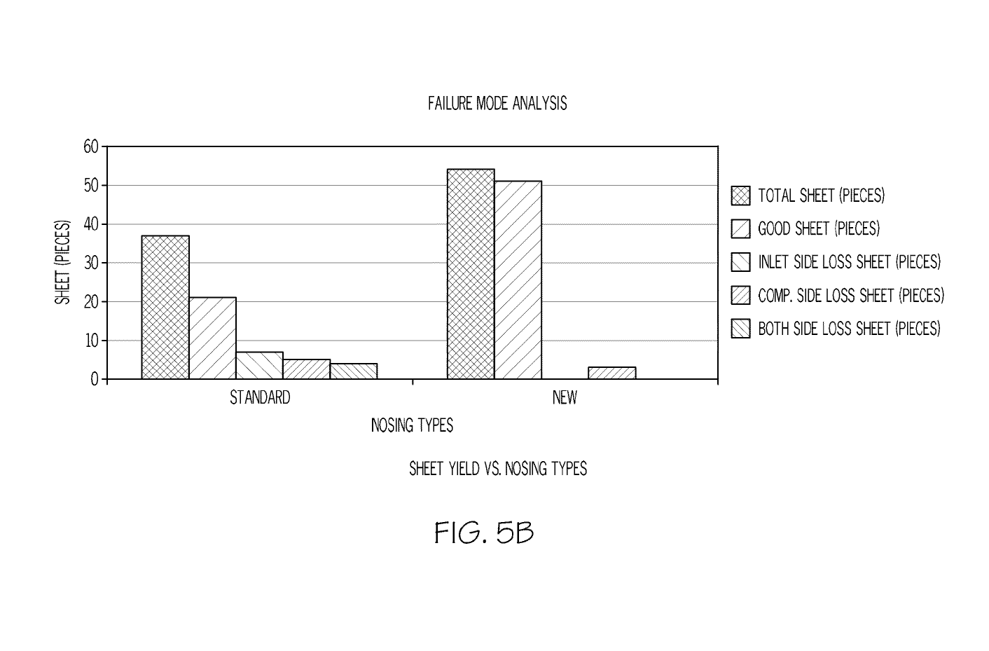

A nosing material with Shore hardness 70 A, static coefficient of friction 1.004, and kinetic coefficient of friction 0.901 was obtained from Dajia Technology Company, Ltd. Specifically, the material is commercially available as silicone rubber. The nosing material was used in a glass separation apparatus with a continuous glass ribbon of less than 0.4 millimeter thickness. The apparatus was first operated with a standard nosing material having a Shore hardness of approximately 64 A, coefficient of static friction approximately 1.45, and coefficient of kinetic friction of approximately 1.29 as a control. The same apparatus was then modified to include the disclosed nosing material, holding all other variables constant. The results of the experiments, shown in FIG. 5A, indicate the disclosed nosing material consistently improved edge quality across the top, middle, and bottom edges of separated glass sheets, and reduced local buckling and vent loss. As reflected in FIG. 5B, the total yield of acceptable separated glass sheets also increased, with minimal glass sheets lost during separation. Other sample nosing materials were used with Shore hardness 70 A, static coefficient of friction ranging from 0.45 to 1.004, and kinetic coefficient of friction ranging from 0.4 to 0.901 and yielded results similar to those shown in FIG. 5A.

The apparatuses and methods for separating a glass sheet from a continuous ribbon of glass described herein are particularly well suited for use in conjunction with glass ribbons which have thicknesses of 0.4 mm or less. The apparatuses and methods described herein may be used to separate glass sheets from glass ribbons, such as the glass ribbons produced with the fusion draw process or similar downdraw processes. It should be understood that stresses, deformation and potential breakage of the glass ribbon during scoring can be substantially mitigated or eliminated by using a nosing material with material properties described herein. Further, breakage of the glass ribbon or the glass sheet in areas adjacent to the intended line of separation may be substantially mitigated or eliminated by using a nosing material as described herein prior to application of a bending moment such that the glass ribbon is unconstrained and free to flex as the bending moment is applied. Accordingly, it should be understood that the apparatuses and methods described herein may be utilized to reduce the occurrence of breakage, buckling, and fractures in the glass ribbon or glass sheets separated from the glass ribbon and thereby reduce waste and improve the edge quality and yield of a glass manufacturing apparatus.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

In a first aspect, the disclosure provides a glass substrate separation apparatus comprising: a support nosing comprising a nosing material having a Shore hardness greater than 64 A and less than or equal to 80 A and a coefficient of friction relative to the glass substrate of less than or equal to 1.2; a scoring device opposing the support nosing; and an actuator coupled to the support nosing for engaging the support nosing with the glass substrate.

In a second aspect, the disclosure provides a method for separating a glass sheet from a glass ribbon, the method comprising: drawing the glass ribbon along a conveyance pathway; directing the glass ribbon through a separation apparatus comprising a support nosing and a scoring device, wherein the conveyance pathway is positioned between the support nosing and the scoring device; engaging a nosing material of the support nosing with at least a portion of a first surface of the glass ribbon; engaging the scoring device with a second surface of the glass ribbon along an intended line of separation, wherein the intended line of separation lies along the support nosing; traversing the scoring device over the second surface of the glass ribbon on the intended line of separation to introduce a partial vent in the second surface of the glass ribbon, wherein: the nosing material has a sufficiently low coefficient of friction relative to the first surface of the glass such that lateral edges of the glass ribbon slide against the nosing material in a lateral direction and the first surface of the glass ribbon contacts the nosing material as the scoring device traverses over the second surface of the glass ribbon; and the nosing material has a sufficiently high hardness such that the partial vent extends across the entire width of the glass ribbon.

In a third aspect, the disclosure provides a method for separating a glass ribbon comprising: positioning a glass ribbon proximate to a support nosing of a separation apparatus, the glass ribbon having a thickness; engaging the glass ribbon with the support nosing using an actuator, where the support nosing comprises a nosing material having a Shore hardness greater than 64 A and less than or equal to 80 A and a coefficient of friction less than or equal to 1.2 relative to the glass ribbon; scoring the glass ribbon with a scoring device positioned opposite the support nosing along an intended line of separation to form a partial vent in a surface of the glass ribbon, wherein the scoring device flattens the glass ribbon against the nosing; and applying a bending moment to the glass ribbon to propagate the vent through the thickness of the glass ribbon.

In a fourth aspect, the disclosure provides the separation apparatus according to the first through third aspects, wherein the nosing material has a coefficient of friction greater than or equal to 0.8 and less than or equal to 1.2 relative to the glass ribbon.

In a fifth aspect, the disclosure provides the separation apparatus according to the first through third aspects, wherein the nosing material has a coefficient of friction greater than or equal to 0.8 and less than or equal to 1.0 relative to the glass ribbon.

In a sixth aspect, the disclosure provides the separation apparatus according to the first through third aspects, wherein the nosing material has a Shore hardness greater than or equal to 68 A and less than or equal to 70 A.

In a seventh aspect, the disclosure provides the separation apparatus according to the first through third aspects, wherein the support nosing is a conformable nosing device.

In an eighth aspect, the disclosure provides the separation apparatus according to the first through third aspects, wherein the support nosing is a fixed nosing device.

In a ninth aspect, the disclosure provides the separation apparatus according to the first through third aspects, wherein the nosing material has a Shore hardness greater than 64 A and less than or equal to 80 A.

What is claimed is:

1. A glass substrate separation apparatus comprising:
a support nosing comprising a nosing material having a Shore hardness greater than 64 A and less than or equal to 80 A and a coefficient of friction relative to the glass substrate of less than or equal to 1.2;
a scoring device opposing the support nosing; and
an actuator coupled to the support nosing for engaging the support nosing with the glass substrate.

2. The separation apparatus of claim 1, wherein the nosing material has a coefficient of friction greater than or equal to 0.8 and less than or equal to 1.2 relative to the glass substrate.

3. The separation apparatus of claim 1, wherein the nosing material has a coefficient of friction greater than or equal to 0.8 and less than or equal to 1.0 relative to the glass substrate.

4. The separation apparatus of claim 3, wherein the nosing material has a Shore hardness greater than or equal to 68 A and less than or equal to 70 A.

5. The separation apparatus of claim 1, wherein the nosing device is a conformable nosing device.

6. The separation apparatus of claim 1, wherein the nosing device is a fixed nosing device.

7. A method for separating a glass sheet from a glass ribbon, the method comprising:
drawing the glass ribbon along a conveyance pathway;
directing the glass ribbon through a separation apparatus comprising a support nosing and a scoring device, wherein the conveyance pathway is positioned between the support nosing and the scoring device;
engaging a nosing material of the support nosing with at least a portion of a first surface of the glass ribbon;
engaging the scoring device with a second surface of the glass ribbon along an intended line of separation, wherein the intended line of separation lies along the support nosing;
traversing the scoring device over the second surface of the glass ribbon on the intended line of separation to introduce a partial vent in the second surface of the glass ribbon, wherein:
the nosing material has a sufficiently low coefficient of friction relative to the first surface of the glass such that lateral edges of the glass ribbon slide against the nosing material in a lateral direction and the first surface of the glass ribbon contacts the nosing material as the scoring device traverses over the second surface of the glass ribbon; and
the nosing material has a sufficiently high hardness such that the partial vent extends across the entire width of the glass ribbon.

8. The method of claim 7, wherein the nosing material has a coefficient of friction greater than or equal to 0.8 and less than or equal to 1.2 relative to the glass ribbon.

9. The method of claim 7, wherein the nosing material has a Shore hardness greater than 64 A and less than or equal to 80 A.

10. The method of claim 7, wherein the nosing material has a coefficient of friction greater than or equal to 0.8 and less than or equal to 1.0 relative to the glass ribbon.

11. The method of claim 10, wherein the nosing material has a Shore hardness greater than or equal to 68 A and less than or equal to 70 A.

12. The method of claim 7, wherein the nosing device is a conformable nosing device.

13. The method of claim 7, wherein the nosing device is a fixed nosing device.

14. A method for separating a glass ribbon comprising:
positioning a glass ribbon proximate to a support nosing of a separation apparatus, the glass ribbon having a thickness;
engaging the glass ribbon with the support nosing using an actuator, where the support nosing comprises a nosing material having a Shore hardness greater than 64 A and less than or equal to 80 A and a coefficient of friction less than or equal to 1.2 relative to the glass ribbon;
scoring the glass ribbon with a scoring device positioned opposite the support nosing along an intended line of separation to form a partial vent in a surface of the glass ribbon, wherein the scoring device flattens the glass ribbon against the nosing; and
applying a bending moment to the glass ribbon to propagate the vent through the thickness of the glass ribbon.

15. The method of claim 14, wherein the nosing material has a coefficient of friction greater than or equal to 0.8 and less than or equal to 1.2 relative to the glass ribbon.

16. The method of claim 14, wherein the nosing material has a coefficient of friction greater than or equal to 0.8 and less than or equal to 1.0 relative to the glass ribbon.

17. The method of claim 16, wherein the nosing material has a Shore hardness greater than or equal to 68 A and less than or equal to 70 A.

18. The method of claim 14, wherein the nosing device is a conformable nosing device.

19. The method of claim 14, wherein the nosing device is a fixed nosing device.
